(19) United States
(12) Patent Application Publication
(10) Pub. No.: US 2006/0204930 A1
(43) Pub. Date: Sep. 14, 2006

(54) Helical implant

(76) Inventor: Young-Taek Sul, Goteborg (SE)

Correspondence Address: Robert E Bushnell;Attorney at Law, Suite 300, 1522 K Street NW, Washington, DC, 20005-1202, US

(21) Appl. No.: 10/550,197

(22) PCT Filed: Mar. 12, 2004
(86) PCT No.: PCT/KR04/00519

§ 371 Date: Sep. 21, 2005

(30) Foreign Application Priority Data
Mar. 26, 2003 (KR) 10-2003-0018745

(51) Int. Cl. A61C 8/00

(52) U.S. Cl. 433/174

(57) ABSTRACT

Disclosed herein is a helical implant. The helical implant is formed with threads theron and each of threads has threads inclines comprising micro-patterns, such as recesses and protrution, on the thread inclines. The micro-patterns on the helical implant may have triangular patterns 100a, stepped patterns 100b and acruate 100c or combination patterns 100d composed of plurality of patterns. The micro-patterns preferably have a cross sectional area of 150 μm. The helical implant has an increased contact area at the fixed portion, so that the volume of the bone induced between the threads 10b is increased from the several dozens of μm level to fifty times that at maximum, thereby dispersing load at the implanted portion and preventing physical damage near the implanted portion.

### BACKGROUND OF THE INVENTION

1. Field of the Invention

The present invention relates to a helical implant, and more particularly to a helical implant, which is formed with micro-patterns on thread inclines of the helical implant fixed in jaw bone tissue, such as the upper jawbone or the lower jawbone, mainly in the field of dentistry.

2. Description of the Related Art

In general, baby teeth are gradually extracted in sequence of their generation from a predetermined time in order to adapt to growth of the maxillary, and replaced with permanent teeth at their places in the mouth. However, in case of the permanent teeth, once one of the permanent teeth is extracted, it does not regrow. Thus, there has been developed a dental operation for providing a substitution when the permanent tooth is extracted due to decay thereof or an accident. As for the dental operation, when there is a tooth near the extracted tooth, a bridge operation, which grinds the tooth near the extracted tooth, has been used, and when there is no adjacent tooth near the extracted tooth for supporting the bridge, a partial or total prosthesis operation, which mounts a partial or total prosthesis on the extracted portion, has been used.

However, the bridge operation has a problem in that damage of the healthy tooth is accompanied with the grinding of the healthy tooth near the extracted tooth. Further, the partial or total prosthesis operation has problems in that there are inconvenience of mounting the prosthesis in the mouth, contact with foreign materials, and damage to the healthy tooth, which contact the prosthesis. Therefore, recently, implant operations are carried out.

In the field of dentistry, the term “implant” generally means an operation, which enables a healthy tooth and oval cavity to be restored by fixing an artificial tooth root as a substitution for the extracted permanent tooth, or as a fixture thereof. Specifically, the term “implant” generally means an operation, in which in order to provide senses and functions, the same as those of the extracted tooth, the artificial tooth root, essentially made of a particular material such as titanium or hydroxyapatite, is transplanted in a jaw bone tissue of the extracted permanent tooth and adhered to the jaw bone, or a fixture thereof. The implant has been developed in various forms and employed since the 1970's.

FIG. 6 is an enlarged view showing thread inclines of a conventional implant. Although various modifications in construction of the implant are well known in the art, a helical implant formed with threads 10b on the outer surface thereof is generally used in the art. As shown in the figure, according to the conventional helical implant, the threads 10b have thread inclines 10a, each having a flat surface, to which surface preparation is not applied, and the thread inclines 10a of two adjacent threads 10b form an inclined angle of thread of approximately 60°.

FIG. 7 is a vertical sectional view of the conventional implant and FIG. 8 is a transverse sectional view of the conventional implant, showing an example of the conventional implant disclosed in EP 1992 0 850 168. As shown in the drawings, the conventional implant is a screw-shaped titanium anchoring member for permanently anchoring a bridge or an artificial tooth in the upper or lower jaw bone particularly when an incisor is extracted, comprising: a cavity for containing scrapped-off jaw bone tissue; a cutting edge formed on the outer cylindrical surface of the cavity for allowing the bottom of the female thread to be naturally defined in the jaw bone tissue; and a clearance surface adjoining the rear side of clearance surface 9 to the cutting edge in a slightly spaced state from the cutting edge at a small angle.

Rotation of the screw-shaped anchoring member 1 causes the cutting edge 5 formed at the lower end of the anchoring member to rotate. As the cutting edge 5 rotates, the cutting edge crushes off jaw bone tissue and provides the naturally defined bottom of the female thread in the jaw bone tissue so as to match the thread of the anchoring member 1, thereby leading to easy implantation of the screw-shaped anchoring member 1. The crushed-off jaw bone tissue is contained in the cavity 4 and adhered near the bottom of the female thread during biting force is not applied thereto after the implantation.

The screw-shaped anchoring member 1 has a planar bottom surface 6. Further, the screw-shaped anchoring member 1 is formed at both sides thereof with conical inclined faces 3, each preferably having a conical angle of 15°˜40°, between the lower end surface 6 and the outer surface at a lower portion of the anchoring member 1. Thus, as the anchoring member 1 rotates and is fixed in the jaw bone, the inclined faces 3 guide the anchoring member 1 to be fixed at a proper position. Further, the clearance surface 9 adjoins at the rear side of the clearance surface 9 to the cutting edge in a slightly spaced state from the cutting edge at the small angle and lowers a squeezing effect of the jaw bone when rotating the anchoring member 1 under pressure.

However, the conventional implant has problems in that due to smoothness of the thread inclines of the anchoring member, a contact area between the screw thread and the bottom of the thread is limited, thereby reducing a mechanical engaging force between the implant and the bone, and in that the cavity of the anchoring member causes reduction in specific volume, lowering a supporting force of the implant.

Further, there are problems in that due to the rotation of the cutting edge, adjoining jaw bone tissue is also damaged, and in that a contact gap can be formed between the implant and the jaw bone tissue, which directly influences the success ratio of the implant operation.

### SUMMARY OF THE INVENTION

The present invention has been made to solve the above problems, and it is an object of the present invention to provide a helical implant, which is formed with a micro-pattern on thread inclines of the helical implant, so that a contact area and a engaging force between the implant and the jaw bone can be increased, and so that stress concentration can be restricted, thereby dispersing a physiological load.

In accordance with one aspect of the present invention, the above and other objects can be accomplished by the provision of a helical implant formed with threads thereon, wherein each of the threads has thread inclines comprising one or more recesses, and wherein the recesses have a polygonal cross section opened at one side thereof.

In accordance with another aspect of the present invention, there is provided a helical implant formed with threads thereon, wherein each of the threads has thread inclines comprising one or more recesses and protrusions, and wherein both the recesses and protrusions have an arcuate cross section of identical curvature and length.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a vertical sectional view of triangular patterns formed on thread inclines of a helical implant according to the present invention;

FIG. 2 is a vertical sectional view of stepped patterns formed on the thread inclines of the helical implant according to the present invention;

FIG. 3 is a vertical sectional view of arcuate patterns formed on the thread inclines of the helical implant according to the present invention;

FIG. 4 is a vertical sectional view of combination patterns formed on the thread inclines of the helical implant according to the present invention;

FIG. 5 is an enlarged view of a micro-machined catheter tube;

FIG. 6 is an enlarged view showing thread inclines of a conventional implant;

FIG. 7 is a vertical sectional view of the conventional implant; and

FIG. 8 is a transverse sectional view of the conventional implant.

### DETAILED DESCRIPTION OF THE PREFERRED EMBODIMENTS

Now, preferred embodiments of the present invention will be described in detail with reference to the accompanying drawings so that those skilled in the art may easily understand and repeat the present invention. The accompanying drawings are provided as an example for illustrating the preferred embodiments of the present invention in detail, and the scope of the present invention is not limited by the drawings and the description referring to the drawings.

A helical implant according to the present invention is formed with threads on the outer surface thereof, and each of the threads has thread inclines formed with one or more recesses or protrusions thereon.

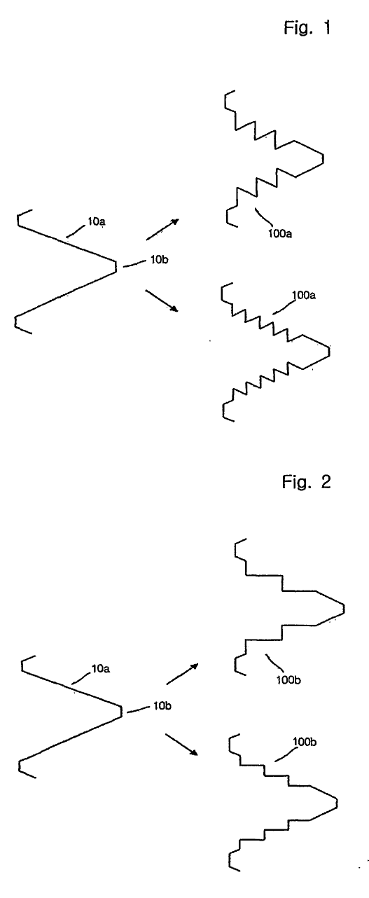

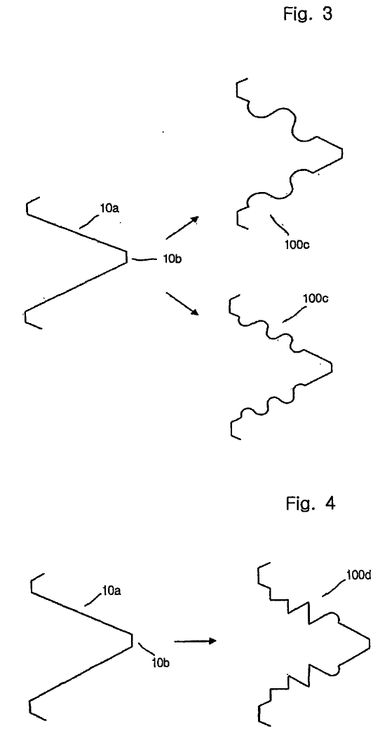

FIGS. 1 to 3 are a vertical sectional view of triangular, stepped and arcuate patterns formed on the thread inclines of the helical implant according to the present invention, respectively. In this specification, the recesses and the protrusions mentioned above are defined as micro-patterns 100a, 100b, 100c and 10d, which are formed by patterning the smooth thread inclines.

Specifically, the recesses mean the micro-patterns formed inwardly on the thread inclines, and the protrusions mean the micro-patterns formed outwardly on the thread inclines. The micro-patterns can be formed in various shapes and in any number, and preferably, an adequate number of the micro-patterns having various shapes may be formed to increase a contact area of the implant. For example, the pattern may have any size in the range of several dozens of gum or several hundreds of μm, such as 30 μm, 50 μm, 80 μm, 100 μm, 150 μm, 250 μm and 300 μm, and has a single shape or a combination of various shapes.

Meanwhile, when the helical implant according to the present invention is fixed in the bone, since a micro-groove needed to grow the jaw bone tissue has a minimum size of about 100 μm, the pattern must be formed to have a size of 100 μm or more, preferably 150 μm. Further, as shown in the drawings, the micro-patterns may be the patterns 100a and 100b having a polygonal cross-section or the patterns 100c having an arcuate cross-section with an identical curvature.

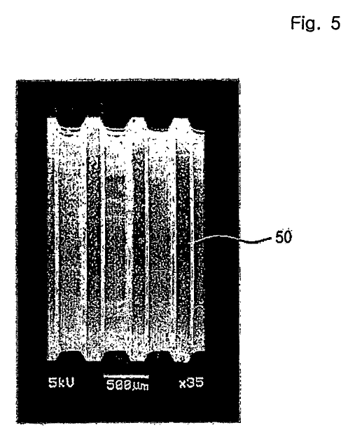

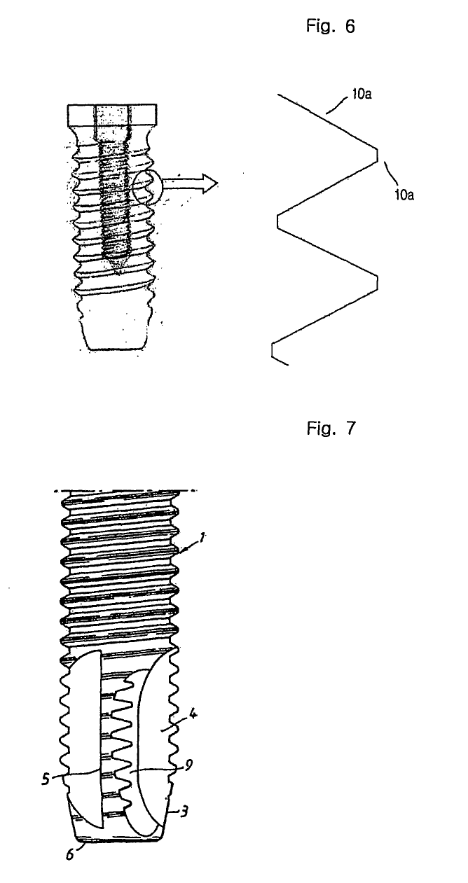

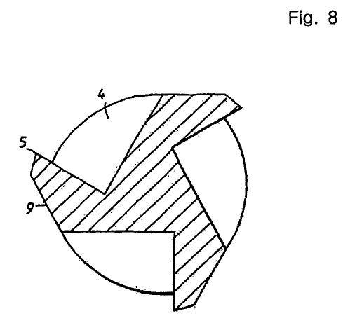

FIG. 4 is a vertical sectional view of combination patterns formed on the thread inclines of the helical implant according to the present invention.

Without being limited to the shape and the number of the patterns, the micro-patterns on the helical implant according to the present invention have the triangular patterns 100a, the stepped patterns 100b and the acruate patterns 100c and the like. Further, as shown in the figure, in addition to the patterns having a predetermined shape, the micro-patterns may be combination patterns 100d composed of a plurality of patterns.

Meanwhile, as the number of the patterns is increased, the contact area of the implant is also remarkably increased, whereas time for machining the patterns is also extended. Thus, preferably, in order to enhance machining efficiency, the patterning process must be performed with reference to the shape, the size and the number of the patterns under consideration of environmental variables for operational condition and physical properties, such as length, horizontal cross-sectional area, thread pitch of the implant, and the like.

As a material for the implant, a highly rigid material, such as hydroxyapatite, which has excellent affinity to the bone and is capable of being easily adhere to regenerating bone, is commercially available. However, when the implant is made of hydroxyapatite, due to limitations in the mechanical strength of hydroxyapatite, it is necessary to increase the cross sectional area of the implant made of the hydroxyapatite. Thus, although the material for the implant according to the present invention is not limited to a particular material, it is desired that the material for the implant is corrosion resistant, high-strength, pure titanium or a titanium alloy.

Thus, in the helical implant according to the preferred embodiment of the present invention, in order to machine the implant made of the high-strength titanium at several hundreds of μm or less level, an ultra-micro machining technique is used for patterning. As for the ultra-micro machining, various techniques well known in the art, such as a laser beam machining technique or lithography technique, can be used, without being limited thereto.

FIG. 5 is an enlarged view of a micro-machined catheter tube. As shown in FIG. 5, the ultra-micro machining technique can machine various medical members, such as a catheter tube 50 at the μm level. Generally, since the thread inclines 10a of the implant have a size of the several hundreds of μm level, in order to form patterns on the thread inclines of the helical implant according to one embodiment of the present invention, preferably, the ultra-micro machining technique based on Micro-Electro Mechanical Systems (MEMS) and Nano-Technology (NT) is used.

As the ultra-micro machining, an ultra high frequency laser beam machining technique, which uses lasers emitted from a source module of optics known in the art, can be used. The ultra high frequency laser beam machining technique emits a laser pulse having a laser pulse width of 100 Femto-seconds with a power of 10 Giga-watts within 60 pico-seconds and machines a medium at the nano level of 10⁻⁹ using the laser pulse.

The ultra high frequency laser beam machining technique can be applied to bio and medical fields, such as living tissues, and can machine a titanium or sapphire medium at an enhanced machining rate of 2 μm per second at high precision. Thus, the ultra high frequency laser beam machining technique can be applied to surface machining of the helical implant made of titanium or the titanium alloy according to the embodiment of the present invention.

Forming of the micro-patterns is accompanied with variation of the contact areas of the thread inclines 10a. For instance, when forming one triangular shaped pattern on one thread incline of the helical implant having a thread incline length of 600 μm, a pitch of 600 μm, an included angle of the thread of 60°, a total length of 10 mm, and vertical cross sectional diameter of 4 mm, the contact area of the implant to the jaw bone is increased about 200%. Further, when forming two regular triangle-shaped patterns on one thread incline, the contact area thereof is increased about 400%, and when forming three regular triangle-shaped patterns on one thread incline, the contact area thereof is increased about 600%. Thus, generally, for the number of the patterns n, the implant area, of which one thread incline can contact the bone tissue, is increased 200n %.

Further, due to the increased contact area, the volume of bone contained between the threads 10b is increased from the several dozens of μm level to fifty times that at maximum.

As apparent from the description, in accordance with the present invention, there are provided advantageous effects in that the helical implant has an increased contact area at the fixed portion and the enhanced mechanical engaging force, and in that due to an increased volume of the bones between the threads, the contact gap between the implant and the implanted portion is reduced. Further, there are provided advantageous effects in that restriction in stress concentration of the implant contributes to dispersion of the load at the implanted portion and to prevention of physical damage near the implanted portion.

Further, there are provided advantageous effects in that the helical implant of the present invention is prevented from loosening, so that it can be applied to any medical operation in which the implant portion is applied to the bone, such as orthopedic medicine, and so that in the field of non-medical use, it can be applied to any kind of implant system comprising the implant defined with a helical appearance.

It should be understood that the embodiments and the accompanying drawings as described above have been described for illustrative purposes and the present invention is limited only by the following claims. Further, those skilled in the art will appreciate that various modifications, additions and substitutions are allowed without departing from the scope and spirit of the invention as set forth in the accompanying claims.

1. A helical implant formed with threads thereon, wherein each of the threads has thread inclines comprising one or more recesses.

2. The helical implant as set forth in claim 1, wherein the recesses have a polygonal cross-section opened at one side thereof.

3. A helical implant formed with threads thereon, wherein each of the threads has thread inclines comprising one or more recesses and protrusions.

4. The helical implant as set forth in claim 3, wherein both the recesses and protrusions have an arcuate cross section of identical curvature and length.

5. The helical implant as set forth in claim 2, wherein the recesses have a cross sectional area of 150 μm.

6. The helical implant as set forth in claim 4, wherein the recesses have a cross sectional area of 150 μm.
